(19) United States
(12) Patent Application Publication
(10) Pub. No.: US 2026/0114510 A1
(43) Pub. Date: Apr. 30, 2026

(54) HEATER ASSEMBLY AND AEROSOL GENERATING DEVICE INCLUDING THE SAME

(71) Applicant: KT&G CORPORATION, Daejeon (KR)

(72) Inventors: In Su Park, Daejeon (KR); Chan Min Kwon, Daejeon (KR); Tae Kyun Kim, Daejeon (KR); Mi Jeong Lee, Daejeon (KR); John Tae Lee, Daejeon (KR); Tae Kyung Lee, Daejeon (KR)

(73) Assignee: KT&G CORPORATION, Daejeon (KR)

(21) Appl. No.: 18/928,824

(22) Filed: Oct. 28, 2024

(30) Foreign Application Priority Data
Aug. 30, 2023 (KR) 10-2023-0114877

(51) Int. Cl. A24F 40/46; A24D 1/20; A24F 40/20; H05B 6/62

(52) U.S. Cl. CPC A24F 40/46; A24D 1/20; A24F 40/20; H05B 6/62

(57) ABSTRACT

A heater assembly includes an oscillator configured to generate microwaves in a specific frequency band, a resonator configured to generate an electric field by resonating the microwaves, and a coupler configured to transmit the generated microwaves to the resonator. The resonator includes a case including an accommodating space accommodating an aerosol generating article and a first opening into which the aerosol generating article is insertable, a plurality of plates spaced apart from each other along a circumferential direction of the aerosol generating article accommodated in the accommodating space, and a connector connecting the plurality of plates and the case and including a second opening corresponding to the first opening, at a location facing the first opening.

### CROSS-REFERENCE TO RELATED APPLICATIONS

This application is based on and claims priority under 35 U.S.C. § 119 to Korean Patent Application Nos. 10-2023-0114877, filed on Aug. 30, 2023, in the Korean Intellectual Property Office, the disclosure of which is incorporated by reference herein in its entirety.

### BACKGROUND

### 1. Field

Embodiments relate to a heater assembly and an aerosol generating device including the same, wherein the heater assembly may generate aerosols by heating an aerosol generating article by using a dielectric heating method.

### 2. Description of the Related Art

Recently, the demand for an alternative method for overcoming shortcomings of general cigarettes has been increased. For example, there is an increasing demand for a system for generating aerosols by heating a cigarette (or an aerosol generating article) by using an aerosol generating device, rather than by burning a cigarette.

A general aerosol generating device generates aerosols by heating an aerosol generating material by using a resistance heating or inductive heating method, but recently, an aerosol generating device using a dielectric heating method, which heats an aerosol generating material by using microwaves, has been proposed.

An aerosol generating device using a dielectric heating method refers to a device that generates heat in a dielectric included in an aerosol generating material according to resonance of microwaves and heats the aerosol generating material through the heat generated in the dielectric.

According to a dielectric heating method, a resonance peak is formed at a specific location of a resonator, and thus, a tobacco rod of an aerosol generating article may be located in an area where the resonance peak occurs for optimal heating. A shape and size of an aerosol generating article vary, and thus, a structure of a resonator, which is able to adaptively respond to the various shapes and sizes, is required.

### SUMMARY

According to an embodiment, provided are a heater assembly and an aerosol generating device, which include a structure for adaptively responding to a shape and size of an aerosol generating article.

Additional aspects will be set forth in part in the description which follows and, in part, will be apparent from the description, or may be learned by practice of the presented embodiments of the disclosure.

A heater assembly according to an embodiment includes an oscillator configured to generate microwaves in a specific frequency band, a resonator configured to generate an electric field by resonating the microwaves, and a coupler configured to transmit the generated microwaves to the resonator. The resonator includes a case including an accommodating space accommodating an aerosol generating article and a first opening into which the aerosol generating article is insertable, a plurality of plates spaced apart from each other along a circumferential direction of the aerosol generating article accommodated in the accommodating space, and a connector connecting the plurality of plates and the case and including a second opening corresponding to the first opening, at a location facing the first opening.

An aerosol generating device according to an embodiment includes a housing including an insertion hole into which an aerosol generating article is inserted, and a heater assembly configured to heat the aerosol generating article inserted through the insertion hole.

The heater assembly includes an oscillator configured to generate microwaves in a specific frequency band, a resonator configured to generate an electric field by resonating the microwaves, and a coupler configured to transmit the generated microwaves to the resonator. The resonator includes a case including an accommodating space accommodating the aerosol generating article and a first opening into which the aerosol generating article is insertable, a plurality of plates spaced apart from each other along a circumferential direction of the aerosol generating article accommodated in the accommodating space, and a connector connecting the plurality of plates and the case and including a second opening corresponding to the first opening, at a location facing the first opening.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of an aerosol generating device according to an embodiment;

FIG. 2 is an internal block diagram of an aerosol generating device according to an embodiment;

FIG. 3 is an internal block diagram of a dielectric heater of FIG. 2;

FIGS. 4 and 5 are diagrams showing examples of an aerosol generating article;

FIG. 6 is a perspective view schematically illustrating a heater assembly according to an embodiment;

FIG. 7 is a perspective view schematically illustrating a heater assembly by cutting a portion thereof, according to another embodiment;

FIG. 8 is an exploded perspective view schematically illustrating components of the heater assembly of FIG. 7, according to an embodiment;

FIG. 9 is a diagram for describing extractors with various lengths, into which aerosol generating articles with various lengths are inserted;

FIG. 10 is a diagram for describing extractors including hole portions;

FIGS. 11A, 11B, and 11C are cross-sectional views showing states in which the extractors of FIG. 9 are inserted into the heater assembly of FIG. 7, respectively;

FIG. 12 is a perspective view schematically illustrating an electric field distribution of the heater assembly of FIG. 11A, according to an embodiment;

FIG. 13 is a perspective view schematically illustrating a heating density distribution of an aerosol generating article heated by the heater assembly of FIG. 11A, according to an embodiment; and

FIG. 14 is a perspective view schematically illustrating a heater assembly according to another embodiment.

### DETAILED DESCRIPTION

Hereinafter, embodiments disclosed in this specification will be described in detail with reference to the accompanying drawings, and identical or similar components will be assigned the same reference numbers, regardless of the drawing symbols, and redundant explanations will be omitted.

The suffixes “module” and “unit” used in this description are assigned or used interchangeably solely for the convenience of drafting the specification and do not themselves have distinct meanings or roles.

Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise.

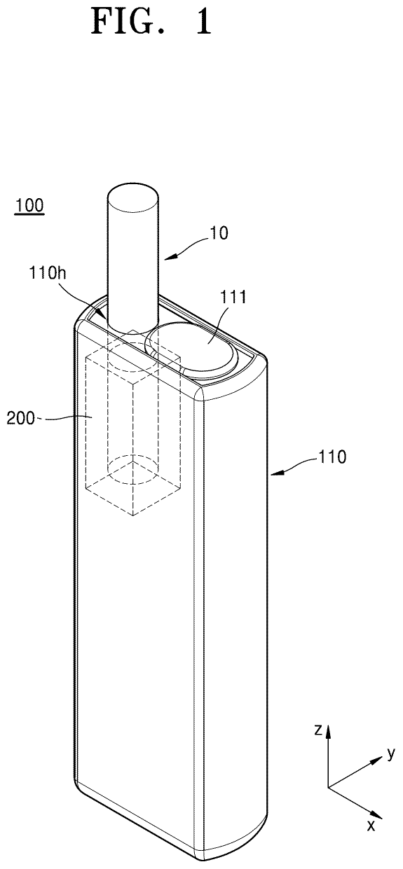

FIG. 1 is a perspective view of an aerosol generating device 100 according to an embodiment.

Referring to FIG. 1, the aerosol generating device 100 according to an embodiment may include a housing 110 accommodating an aerosol generating article 10, and a heater assembly 200 configured to heat the aerosol generating article 10 accommodated in the housing 110.

The housing 110 may form an overall exterior of the aerosol generating device 100 and components of the aerosol generating device 100 may be arranged in an internal space (or a mounting space) of the housing 110. For example, the heater assembly 200, a battery, a processor, and/or a sensor may be arranged in the internal space of the housing 110, but the components arranged in the internal space are not limited thereto.

An insertion hole 110h may be formed in one area of the housing 110, and at least one area of the aerosol generating article 10 may be inserted into the housing 110 through the insertion hole 110h. For example, the insertion hole 110h may be formed in one area of a top surface (e.g., a surface facing a z direction) of the housing 110, but a location of the insertion hole 110h is not limited thereto. According to another embodiment, the insertion hole 110h may be formed in one area of a side surface (e.g., a surface facing an x direction) of the housing 110.

The heater assembly 200 is arranged in the internal space of the housing 110 and heat the aerosol generating article 10 inserted into or accommodated in the housing 110 through the insertion hole 110h. For example, the heater assembly 200 may heat the aerosol generating article 10 by being arranged to surround at least one area of the aerosol generating article 10 inserted into or accommodated in the housing 110.

According to an embodiment, the heater assembly 200 may heat the aerosol generating article 10 by using a dielectric heating method. In the disclosure, the dielectric heating method is a method of heating a dielectric that is an object to be heated, by using resonance of microwaves and/or an electric field (or including a magnetic field) of microwaves. Microwaves are an energy source for heating the object to be heated and are generated by high-frequency power, and thus, microwaves may be interchangeably used with microwave power.

Charges or ions of the dielectric included in the aerosol generating article 10 may vibrate or rotate inside the heater assembly 200 by microwave resonance, and heat may be generated in the dielectric by frictional heat generated when the charges or ions vibrate or rotate, and thus, the aerosol generating article 10 may be heated.

When the aerosol generating article 10 is heated by the heater assembly 200, aerosols may be generated from the aerosol generating article 10. In the disclosure, aerosols may refer to gas particles generated when the air and vapor generated as the aerosol generating article 10 is heated are mixed with each other.

The aerosols generated from the aerosol generating article 10 may be discharged to the outside of the aerosol generating device 100 by passing through the aerosol generating article 10 or through an empty space between the aerosol generating article 10 and the insertion hole 110h. A user may smoke by bringing his/her mouth into contact with one area of the aerosol generating article 10 exposed to the outside of the housing 110 and inhale the aerosols discharged to the outside of the aerosol generating device 100.

The aerosol generating device 100 according to an embodiment may further include a cover 111 movably arranged in the housing 110 to open or close the insertion hole 110h. For example, the cover 111 may be slidably combined to the top surface of the housing 110 to expose the insertion hole 110h to the outside of the aerosol generating device 100 or cover the insertion hole 110h so that the insertion hole 110h is not exposed to the outside of the aerosol generating device 100.

According to an embodiment, the cover 111 may expose the insertion hole 110h to the outside of the aerosol generating device 100 at a first location (or an opening location). When the insertion hole 110h is exposed to the outside, the aerosol generating article 10 may be inserted into the housing 110 through the insertion hole 110h.

According to another embodiment, the cover 111 may cover the insertion hole 110h at a second location (or a closing location) so that the insertion hole 110h is not exposed to the outside of the aerosol generating device 100. Here, the cover 111 may prevent external impurities from entering into the heater assembly 200 through the insertion hole 110h when the aerosol generating device 100 is not used.

FIG. 1 illustrates only the aerosol generating device 100 for heating the aerosol generating article 10 in a solid state, but the aerosol generating device 100 is not limited thereto.

An aerosol generating device according to another embodiment may generate aerosols by heating an aerosol generating material in a liquid or gel state, instead of the aerosol generating article 10 in a solid state, through the heater assembly 200.

An aerosol generating device according to another embodiment may include the heater assembly 200 configured to heat the aerosol generating article 10 and a cartridge (or a vaporizer) including an aerosol generating material in a liquid or gel state and configured to heat the aerosol generating material. Aerosols generated from the aerosol generating material may move to the aerosol generating article 10 along an airflow passage communicated with the cartridge and the aerosol generating article 10 to each other and be mixed with aerosols generated from the aerosol generating article 10, and then transmitted to a user through the aerosol generating article 10.

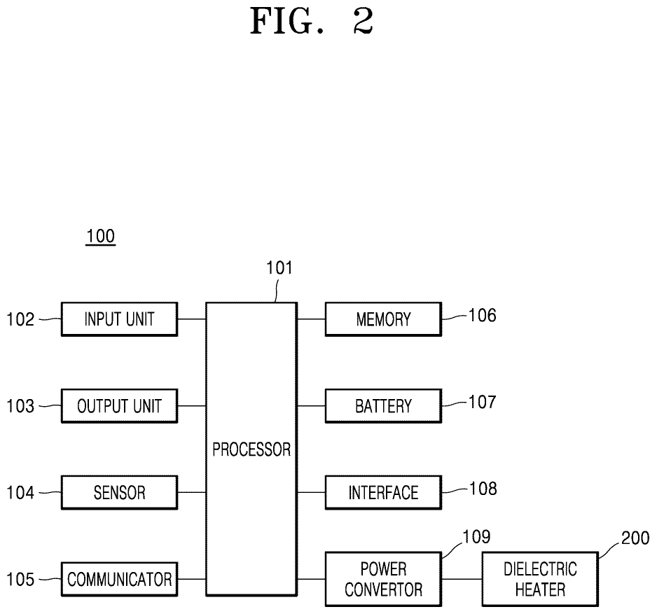

FIG. 2 is an internal block diagram of the aerosol generating device 100 according to an embodiment.

Referring to FIG. 2, the aerosol generating device 100 may include an input unit 102, an output unit 103, a sensor 104, a communicator 105, a memory 106, a battery 107, an interface 108, a power convertor 109, and a dielectric heater 200. However, an internal structure of the aerosol generating device 100 is not limited to those illustrated in FIG. 2. According to a design of the aerosol generating device 100, some of the components shown in FIG. 2 may be omitted or a new component may be added.

The input unit 102 may be configured to receive a user input. For example, the input unit 102 may be provided as a single pressurizing type push button. In another example, the input unit 102 may be a touch panel including at least one touch sensor. The input unit 102 may transmit an input signal to a processor 101. The processor 101 may supply power to the dielectric heater 200 based on the user input or output a user notification by controlling the output unit 103.

The output unit 103 may output information about a state of the aerosol generating device 100. The output unit 103 may output information about a charging/discharging state of the battery 107, a heating state of the dielectric heater 200, an insertion state of the aerosol generating article 10, and an error of the aerosol generating device 100. In this regard, the output unit 103 may include a display, a haptic motor, and a sound output unit.

The sensor 104 may sense a state of the aerosol generating device 100 or a state around the aerosol generating device 100, and transmit sensed information to the processor 101. Based on the sensed information, the processor 101 may control the aerosol generating device 100 to perform various functions, such as controlling heating of the dielectric heater 200, limiting smoking, determining whether the aerosol generating article 10 is inserted, displaying a notification, and the like.

The sensor 104 may include a temperature sensor, a puff sensor, and an insertion detection sensor.

The temperature sensor may detect a temperature inside the dielectric heater 200 in a non-contact manner or may directly obtain a temperature of a resonator by contacting the dielectric heater 200. According to an embodiment, the temperature sensor may detect a temperature of the aerosol generating article 10. Also, the temperature sensor may be arranged adjacent to the battery 107 to obtain a temperature of the battery 107. The processor 101 may control power supplied to the dielectric heater 200, based on temperature information of the temperature sensor.

The puff sensor may detect a puff of the user. The puff sensor may detect a puff of the user, based on at least one of a temperature change, a flow change, a power change, and a pressure change. The processor 101 may control power supplied to the dielectric heater 200, based on puff information of the puff sensor. For example, the processor 101 may count the number of puffs and block power supplied to the dielectric heater 200 when the number of puffs reaches a pre-set maximum number of puffs. In another example, the processor 101 may block power supplied to the dielectric heater 200 when a puff is not detected for a pre-set period of time or more.

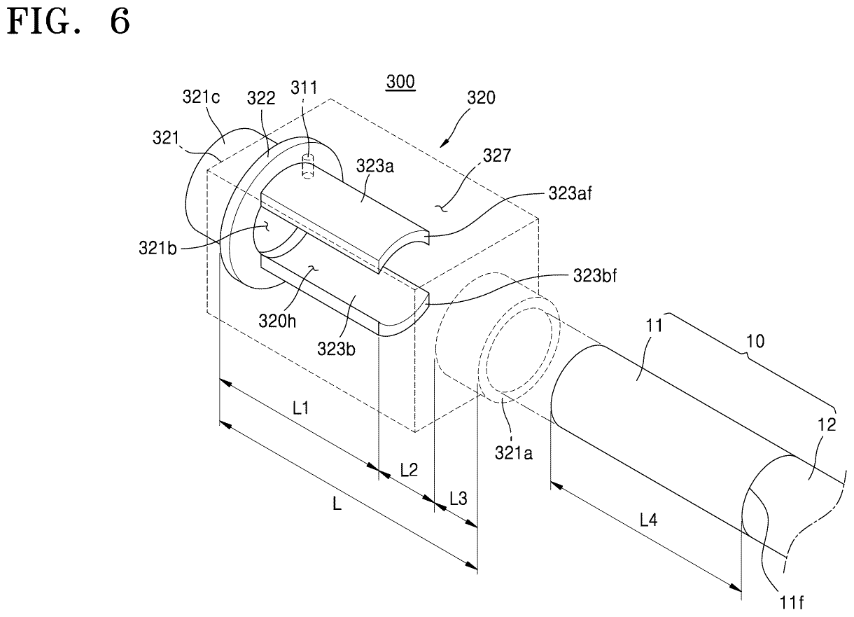

The insertion detection sensor may be arranged inside an accommodating space 320h of FIG. 6 or adjacent to the accommodating space 320h and detect insertion and removal of the aerosol generating article 10 accommodated in the insertion hole 110h. For example, the insertion detection sensor may include an inductive sensor and/or a capacitance sensor. The processor 101 may supply power to the dielectric heater 200 when the aerosol generating article 10 is inserted into the insertion hole 110h.

According to an embodiment, the sensor 104 may further include a reuse detection sensor, a motion detection sensor, a humidity sensor, an atmospheric pressure sensor, a magnetic sensor, a cover removal detection sensor, a location sensor (global positioning system (GPS)), and a proximity sensor. Because functions of each sensor may be intuitively inferred by one of ordinary skill in the art from the name, detailed descriptions thereof will be omitted.

The communicator 105 may include at least one communication module for communication with an external electronic device. The processor 101 may control the communicator 105 to transmit information about the aerosol generating device 100 to the external electronic device. Alternatively, the processor 101 may receive information from the external electronic device through the communicator 105 to control the components included in the aerosol generating device 100. For example, information transmitted between the communicator 105 and the external electronic device may include user authentication information, firmware update information, and user smoking pattern information.

The memory 106 is hardware storing various types of data processed in the aerosol generating device 100, and may store data processed and data to be processed by the processor 101. The memory 106 may store an operation time of the aerosol generating device 100, the maximum number of puffs, the current number of puffs, at least one temperature profile, data on the user's smoking pattern, and the like.

The battery 107 may supply power to the dielectric heater 200 such that the aerosol generating article 10 may be heated. Also, the battery 107 may supply power required for operations of other components included in the aerosol generating device 100. The battery 107 may be a rechargeable battery or a detachable and removable battery.

The interface 108 may include a connecting terminal that may be physically connected to the external electronic device. For example, the connecting terminal may include at least one or a combination of a high-definition multimedia interface (HDMI) connector, a universal serial bus (USB) connector, a secure digital (SD) card connector, and an audio connector (e.g., a headphone connector). The interface 108 may transmit or receive information to or from the external electronic device through the connecting terminal, or charge a power source.

The power convertor 109 may convert direct current power supplied from the battery 107 into alternating current power. Also, the power convertor 109 may provide the alternating current power to the dielectric heater 200. The power convertor 109 may be an inverter including at least one switching device and the processor 101 may control on/off of the switching device included in the power convertor 109 to convert direct current power into alternating current power. The power convertor 109 may be configured as a full-bridge or a half-bridge.

The dielectric heater 200 may heat the aerosol generating article 10 by using a dielectric heating method. The dielectric heater 200 may be a component corresponding to the heater assembly 200 of FIG. 1.

The dielectric heater 200 may heat the aerosol generating article 10 by using microwaves and/or an electric field of microwaves (hereinafter, referred to as microwaves or microwave power when distinction is not required). A heating method of the dielectric heater 200 may be a method of heating an object to be heated by forming microwaves in a resonance structure, instead of radiating microwaves by using an antenna. The resonance structure will be described below with reference to FIG. 6.

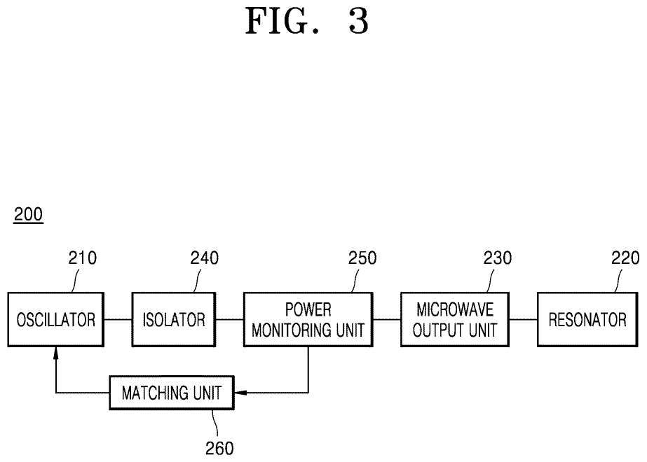

The dielectric heater 200 may output microwaves that is a high frequency to a resonator 220 of FIG. 3. Microwaves may be power in an industrial scientific and medical equipment (ISM) band allowed for heating, but are not limited thereto. The resonator 220 may be designed considering a wavelength of microwaves so that microwaves may resonate in the resonator 220.

The aerosol generating article 10 may be inserted into the resonator 220 and a dielectric material in the aerosol generating article 10 may be heated by the resonator 220. For example, the aerosol generating article 10 may include a polar material and molecules in the polar material may be polarized inside the resonator 220. The molecules may vibrate or rotate according to a polarization phenomenon and the aerosol generating article 10 may be heated by frictional heat generated during such a process. Details about the dielectric heater 200 will be described in detail below with reference to FIG. 3.

The processor 101 may control general operations of the aerosol generating device 100. The processor 101 may be implemented in an array of a plurality of logic gates, or in a combination of a general-purpose microprocessor and a memory storing a program executable by the general-purpose microprocessor. The processor 101 may be implemented in another form of hardware.

The processor 101 may control direct current power supplied from the battery 107 to the power convertor 109 or alternating current power supplied from the power convertor 109 to the dielectric heater 200, according to power demand of the dielectric heater 200. According to an embodiment, the aerosol generating device 100 may include a converter configured to boost or lower the direct current power, and the processor 101 may adjust a size of the direct current power by controlling the converter. Also, the processor 101 may control the alternating current power supplied to the dielectric heater 200 by adjusting a switching frequency and duty ratio of the switching device included in the power convertor 109.

The processor 101 may control a heating temperature of the aerosol generating article 10 by controlling microwave power of the dielectric heater 200 and a resonating frequency of the dielectric heater 200. Accordingly, an oscillator 210, an isolator 240, a power monitoring unit 250, and a matching unit 260 of FIG. 3 described below may be some components of the processor 101.

The processor 101 may control microwave power of the dielectric heater 200, based on temperature profile information stored in the memory 106. In other words, a temperature profile may include information about a target temperature of the dielectric heater 200 according to time, and the processor 101 may control microwave power of the dielectric heater 200 according to time.

The processor 101 may adjust a frequency of microwaves so that the resonating frequency of the dielectric heater 200 is not uniform. The processor 101 may track, in real time, a change in the resonating frequency of the dielectric heater 200 according to heating of an object to be heated, and control the dielectric heater 200 so that a microwave frequency according to the changed resonating frequency is output. In other words, the processor 101 may change the microwave frequency in real time regardless of the pre-stored temperature profile.

FIG. 3 is an internal block diagram of the dielectric heater 200 of FIG. 2.

Referring to FIG. 3, the dielectric heater 200 may include the oscillator, the isolator 240, the power monitoring unit 250, the matching unit 260, a microwave output unit 230, and the resonator 220. However, an internal configuration of the dielectric heater 200 is not limited to that shown in FIG. 3. According to a design of the dielectric heater 200, some of the components shown in FIG. 3 may be omitted or a new component may be added.

The oscillator 210 may receive alternating current power from the power convertor 109 and generate microwave power of high frequency. According to an embodiment, the power convertor 109 may be included in the oscillator 210. The microwave power may be selected from frequency bands of 915 MHz, 2.45 GHZ, and 5.8 GHZ, which are included in ISM bands.

The oscillator 210 may include a solid-state-based radio frequency (RF) generating apparatus and generate the microwave power by using the same. The solid-state-based RF generating apparatus may be implemented in a semiconductor. When the oscillator 210 is implemented in a semiconductor, the dielectric heater 200 may be miniaturized and device lifespan may be increased.

The oscillator 210 may output the microwave power towards the resonator 220. The oscillator 210 may include a power amplifier configured to increase or decrease the microwave power and the power amplifier may adjust a size of the microwave power according to control by the processor 101. For example, the power amplifier may decrease or increase amplitude of microwaves. The microwave power may be adjusted by adjusting the amplitude of microwaves.

The processor 101 may adjust the size of the microwave power output from the oscillator 210, based on a pre-stored temperature profile. For example, the temperature profile may include information about a target temperature according to a preheating period and a smoking period, and the oscillator 210 may supply the microwave power of first power during the preheating period and supply the microwave power of second power lower than the first power during the smoking period.

The isolator 240 may block the microwave power input from the resonator 220 towards the oscillator 210. The microwave power output by the oscillator 210 is mostly absorbed by an object to be heated, but part of the microwave power may be reflected at the object to be heated and transmitted back to the oscillator 210, depending on a heating pattern of the object to be heated. This is because impedance viewed from the oscillator 210 to the resonator 220 changes according to depletion of polar molecules due to heating of the object to be heated. The meaning that the impedance viewed from the oscillator 210 to the resonator 220 changes is the same as the meaning that the resonating frequency of the resonator 220 changes. When the microwave power reflected at the resonator 220 is input to the oscillator 210, not only the oscillator 210 malfunctions, but also an expected output performance may not be achieved. The isolator 240 may not return the microwave power reflected at the resonator 220 back to the oscillator 210, but may induce the microwave power in a certain direction and absorb the same. In this regard, the isolator 240 may include a circulator and a dummy load.

The power monitoring unit 250 may monitor each of microwave power output from the oscillator 210 and reflection microwave power reflected at the resonator 220. The power monitoring unit 250 may transmit, to the matching unit 260, information about the microwave power and the reflection microwave power.

The matching unit 260 may match impedance viewed from the oscillator 210 to the resonator 220 with impedance viewed from the resonator 220 to the oscillator 210, so that the reflection microwave power is minimized. Impedance matching may have a same meaning as matching a frequency of the oscillator 210 and the resonating frequency of the resonator 220. Accordingly, to match the impedance, the matching unit 260 may vary a frequency of the oscillator 210. In other words, the matching unit 260 may adjust a frequency of the microwave power output from the oscillator 210 so that the reflection microwave power is minimized. The impedance matching of the matching unit 260 may be performed in real time regardless of the temperature profile.

The oscillator 210, the isolator 240, the power monitoring unit 250, and the matching unit 260 are separate components distinguished from the microwave output unit 230 and the resonator 220 described below, and may be implemented as a microwave source in the form of a chip. Also, according to an embodiment, the oscillator 210, the isolator 240, the power monitoring unit 250, and the matching unit 260 may be implemented as a partial configuration of the processor 101.

The microwave output unit 230 is a component configured to input the microwave power to the resonator 220 and may correspond to a coupler of FIG. 3 and below. The microwave output unit 230 may be implemented in the form of a SubMiniature Version A (SMA), SubMiniature Version B (SMB), Micro Coaxial (MCX), or Micro-Miniature Coaxial (MMCX) connector. The microwave output unit 230 may connect the resonator 220 to the microwave source in the form of a chip so as to transmit microwave power generated in the microwave source to the resonator 220.

The resonator 220 may heat the object to be heated by forming microwaves in a resonance structure. The resonator 220 may include an accommodating space in which the aerosol generating article 10 is accommodated and the aerosol generating article 10 may be dielectrically heated by being exposed to microwaves. For example, the aerosol generating article 10 may include a polar material and molecules in the polar material may be polarized inside the resonator 220 by microwaves. The molecules may vibrate or rotate according to a polarization phenomenon and the aerosol generating article 10 may be heated by frictional heat generated during such a process.

The resonator 220 includes at least one internal conductor for microwaves to resonate, and the microwaves may resonate inside the resonator 220 according to an arrangement, thickness, and length of the internal conductor.

The resonator 220 may include a dielectric accommodating space. The dielectric accommodating space is a configuration distinguished from an accommodating space of the aerosol generating article 10, and a material for miniaturizing the resonator 220 by changing an entire resonating frequency of the resonator 220 may be arranged. According to an embodiment, the dielectric accommodating space may accommodate a dielectric having a low degree of microwave absorption. This is to prevent a phenomenon in which the dielectric self-generates heat as energy to be transmitted to the object to be heated is transmitted to the dielectric. The degree of microwave absorption may be represented as a loss tangent that is a ratio of an imaginary part to a real part of a complex dielectric constant. According to an embodiment, the dielectric accommodating space may accommodate a dielectric having a loss tangent equal to or less than a pre-set size, wherein the pre-set size may be 1/100. For example, the dielectric may be any one or a combination of quartz, tetrafluoroethylene, and an aluminum oxide, but is not limited thereto.

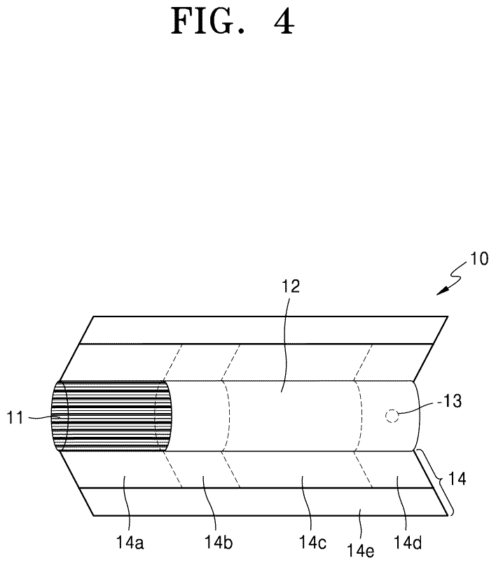

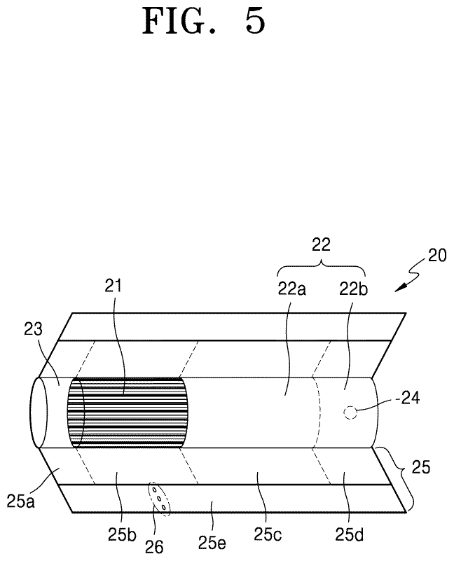

Hereinafter, examples of aerosol generating articles 10 and 20 will be described with reference to FIGS. 4 and 5.

FIGS. 4 and 5 are diagrams showing examples of the aerosol generating articles 10 and 20.

Referring to FIG. 4, the aerosol generating article 10 includes a tobacco rod 11 and a filter rod 12.

In FIG. 4, the filter rod 12 is a single segment, but is not limited thereto. In other words, the filter rod 12 may include a plurality of segments. For example, the filter rod 12 may include a first segment configured to cool down aerosols and a second segment configured to filter out a certain component included in the aerosols. In addition, according to necessity, the filter rod 12 may further include at least one segment configured to perform other functions.

The aerosol generating article 10 may be wrapped by at least one wrapper 14. The wrapper 14 may have at least one hole through which external air is introduced or an internal gas is discharged. For example, the aerosol generating article 10 may be wrapped by one wrapper 14. In another example, the aerosol generating article 19 may be repeatedly wrapped by two or more wrappers 14. For example, the tobacco rod 11 may be wrapped by a first wrapper 14a, and the filter rod 12 may be wrapped by wrappers 14b, 14c, and 14d. Also, the aerosol generating article 10 may be entirely rewrapped by a single wrapper 14e. When the filter rod 12 includes a plurality of segments, the plurality of segments may be respectively wrapped by the wrappers 14b, 14c, and 14d.

The tobacco rod 11 includes an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. In addition, the tobacco rod 11 may include other additives, such as flavors, a wetting agent, and/or organic acid. Also, the tobacco rod 11 may include a flavored liquid, such as menthol or a moisturizer, which is injected to the tobacco rod 11.

The tobacco rod 11 may be manufactured in various forms. For example, the tobacco rod 11 may be formed as a sheet or a strand. Also, the tobacco rod 11 may also be formed as a pipe tobacco, which is formed of tiny bits cut from a tobacco sheet.

A length of the tobacco rod 11 according to an embodiment may vary depending on design necessity. For example, the length of the tobacco rod 11 may be about 15 mm or about 25 mm.

The filter rod 12 may be a cellulose acetate filter. A shape of the filter rod 12 is not limited. For example, the filter rod 12 may include a cylinder-type rod or a tube-type rod having a hollow inside. In addition, the filter rod 12 may also be a recess-type rod. When the filter rod 12 includes a plurality of segments, at least one of the plurality of segments may have a different shape.

The filter rod 12 may be manufactured to generate a flavor. For example, a flavored liquid may be injected into the filter rod 12 or a separate fiber coated with a flavored liquid may be inserted into the filter rod 12.

In addition, at least one capsule 13 may be included in the filter rod 12. The capsule 13 may generate a flavor or aerosols. For example, the capsule 13 may have a configuration in which a liquid containing a flavoring material is wrapped with a film. The capsule 13 may have a spherical or cylindrical shape, but is not limited thereto.

When the filter rod 12 includes a segment configured to cool down aerosols, such a cooling segment may include a polymer material or a biodegradable polymer material. For example, the cooling segment may include only pure polylactic acid, but is not limited thereto. Alternatively, the cooling segment may include a cellulose acetate filter having a plurality of holes. The cooling segment is not limited to the above examples as long as the cooling segment performs a function of cooling down aerosols.

Referring to FIG. 5, the aerosol generating article 20 may further include a front end plug 23. The front end plug 23 may be positioned on one side of a tobacco rod 21, which is opposite to a filter rod 22. The front end plug 23 may prevent the tobacco rod 21 from being detached outwards and prevent liquefied aerosols from flowing into an aerosol generating device (or a heater assembly) from the tobacco rod 21, during smoking.

The filter rod 22 may include a first segment 22a and a second segment 22b. Here, the first segment 22a may correspond to the first segment of the filter rod 12 of FIG. 4, and the second segment 22b may correspond to the second segment of the filter rod 12 of FIG. 4.

A length of the front end plug 23 according to an embodiment may be shorter than a length of the tobacco rod 21. For example, when the length of the tobacco rod 11 is about 15 mm, the length of the front end plug 23 may be about 7 mm.

The aerosol generating article 20 may be wrapped by at least one wrapper 25. The wrapper 25 may have at least one hole through which external air is introduced or an internal gas is discharged. For example, the front end plug 23 may be wrapped by a first wrapper 25a, the tobacco rod 21 may be wrapped by a second wrapper 25b, the first segment 22a may be wrapped by a third wrapper 25c, and the second segment 22b may be wrapped by a fourth wrapper 25d. Also, the aerosol generating article 20 may be entirely rewrapped by a fifth wrapper 25e.

In addition, at least one perforation 26 may be formed in the fifth wrapper 25e. For example, the perforation 26 may be formed in a region surrounding the tobacco rod 21, but is not limited thereto.

In addition, at least one capsule 24 may be included in the second segment 22b. The capsule 24 may generate a flavor or aerosols. For example, the capsule 24 may have a configuration in which a liquid containing a flavoring material is wrapped with a film. The capsule 24 may have a spherical or cylindrical shape, but is not limited thereto.

FIG. 6 is a perspective view schematically illustrating a heater assembly 300 according to an embodiment.

The heater assembly 300 of FIG. 6 according to an embodiment may include a resonator 320 configured to generate microwave resonance and a coupler 311 configured to supply microwaves to the resonator 320.

The resonator 320 may include a case 321, a plurality of plates 323a and 323b, and a connector 322 connecting the plurality of plates 323a and 323b to the case 321.

The coupler 311 may supply microwaves to at least one of the plurality of plates 323a and 323b so that the resonator 320 generates microwave resonance.

The resonator 320 may surround at least one area of the aerosol generating article 10 inserted into an aerosol generating device. The coupler 311 may supply microwaves generated in an oscillator (not shown) to the resonator 320. When microwaves are supplied to the resonator 320, microwave resonance is generated in the resonator 320 and thus the resonator 320 may heat the aerosol generating article 10. For example, dielectrics included in the aerosol generating article 10 may generate heat by an electric field generated inside the resonator 220 by microwaves, and the aerosol generating article 10 may be heated by heat generated in the dielectrics.

Because the inside of the case 321 of the resonator 320 has a hollow shape, components of the resonator 320 may be arranged inside the case 321.

The case 321 may include an accommodating space 320h in which the aerosol generating article 10 may be accommodated, and a first opening 321a into which the aerosol generating article 10 may be inserted. The first opening 321a is connected to the accommodating space 320h. Because the first opening 321a is open towards the outside of the case 321, the accommodating space 320h is connected to the outside through the first opening 321a. Accordingly, the aerosol generating article 10 may be inserted into the accommodating space 320h of the case 321 through the first opening 321a of the case 321.

The case 321 shown in FIG. 6 has a square cross-sectional shape, but a shape of the case 321 may be modified into various shapes. For example, the case 321 may be modified to have various cross-sectional shapes such as a rectangle, an oval, or a circle. The case 321 may extend in one direction.

The plurality of plates 323a and 323b may be arranged inside the case 321.

The plurality of plates 323a and 323b may be spaced apart from each other along a circumferential direction of the aerosol generating article 10 accommodated in the accommodating space 320h. The plurality of plates 323a and 323b may include a first plate 323a arranged to surround one area of the aerosol generating article 10, and a second plate 323b arranged to surround another area of the aerosol generating article 10.

The plurality of plates 323a and 323b may be connected to the case 321 via the connector 322. Also, one end of the first plate 323a and one end of the second plate 323b may be connected to each other by the connector 322.

The connector 322 may include a second opening 321b corresponding to the first opening 321a, at a location facing the first opening 321a. The second opening 321b may be formed in the connector 322 for fluid communication with the first opening 321a. For example, the second opening 321b may be aligned in a length direction of the aerosol generating article 10 with respect to the first opening 321a and an open end portion of another end 323af of the plurality of plates 323a and 323b. Thus, one end of the aerosol generating article 10 according to an embodiment may be inserted through the first opening 321a of the case 321 and pass through the second opening 321b of the connector 322. Here, an outer circumferential surface of the aerosol generating article 10 may include a band (not shown) indicating an insertion location. When the band of the aerosol generating article 10 is located at a front end portion of the first opening 321a, the tobacco rod 11 may be arranged to correspond to an area where an electric field is strongest.

A shape and size of the second opening 321b according to an embodiment may correspond to a shape and size of the first opening 321a. For example, when the first opening 321a has a circular shape, the second opening 321b also has a circular shape, and an inner diameter of the first opening 321a and an inner diameter of the second opening 321b may be substantially the same.

The one end of the first plate 323a and the one end of the second plate 323b may be arranged along a circumference of the second opening 321b of the connector 322. Also, the other end 323af of the first plate 323a and the other end 323bf of the second plate 323b may be spaced apart from each other and open. A resonator assembly may be completed as the plurality of plates 323a and 323b are connected to the connector 322.

The connector 322 may have one surface where the plurality of plates 323a and 323b are arranged, and another surface including a tubular protruding portion 321c extending from the second opening 321b. The tubular protruding portion 321c may be aligned in the length direction of the aerosol generating article 10 with respect to the second opening 321b, the open end portion of the other end 323af of the plurality of plates 323a and 323b, and the first opening 321a.

The resonator 320 may include a short end of which a cross section is closed to have a ¼ length (λ/4) of a wavelength (λ) of microwaves, and an open end of which at least one area of a cross section is open and located in a direction opposite to the short end.

In FIG. 6, an area at one end of the resonator 320, which corresponds to a left area, has a structure in which microwaves are substantially prevented from being discharged to the outside by the tubular protruding portion 321c, and thus forms the closed short end. In FIG. 6, an area at another end of the resonator 320, which corresponds to a right area, has a structure in which the plurality of plates 323a and 323b are open, and thus forms the open end. According to such a structure of the resonator 320, the resonator 320 may operate as a resonator having a ¼ wavelength of microwaves.

The plurality of plates 323a and 323b extend in the length direction of the aerosol generating article 10. At least a portion of the plurality of plates 323a and 323b may be curved to protrude outward from a center of the length direction of the aerosol generating article 10.

For example, when the aerosol generating article 10 has a cylindrical shape, the plurality of plates 323a and 323b may be curved in a circumferential direction along an outer circumferential surface of the aerosol generating article 10. A radius of curvature of a cross section of the plurality of plates 323a and 323b may be the same as a radius of curvature of the aerosol generating article 10. The radius of curvature of the cross section of the plurality of plates 323a and 323b may be variously modified. For example, the radius of curvature of the cross section of the plurality of plates 323a and 323b may be greater than or smaller than the radius of curvature of the aerosol generating article 10.

According to a structure in which the plurality of plates 323a and 323b are curved in the circumferential direction along the outer circumferential surface of the aerosol generating article 10, a further uniform electric field is formed in the resonator 320, and thus, the heater assembly 300 may uniformly heat the aerosol generating article 10.

The open end portion at the other end of the plurality of plates 323a and 323b may be located to face the first opening 321a of the case 321. The first opening 321a of the case 321 may be separated in a direction away from the other end of the plurality of plates 323a and 323b.

The open end portion at the other end of the plurality of plates 323a and 323b may be aligned with respect to the first opening 321a of the case 321. Accordingly, when the aerosol generating article 10 is inserted through the first opening 321a of the case 321 and located in the accommodating space 320h, a portion of the aerosol generating article 10 located in the accommodating space 320h may be surrounded by the plurality of plates 323a and 323b.

The two plates 323a and 323b are arranged at opposite locations based on the center of the length direction of the aerosol generating article 10. Embodiments are not limited by the number of plurality of plates 323a and 323b, and the number of plurality of plates 323a and 323b may be, for example, 3 or more.

The plurality of plates 323a and 323b may be arranged symmetrical based on the length direction of the aerosol generating article 10, i.e., a central axis of a direction in which the aerosol generating article 10 extends.

At least one of the plurality of plates 323a and 323b may be in contact with the coupler 311 connected to the oscillator (not shown). In detail, the first plate 323a may be at least partially in contact with the coupler 311. When microwaves are transmitted to the first plate 323a through the coupler 311, microwave resonance is generated between the plurality of plates 323a and 323b. Also, microwave resonance is generated between the first plate 323a and an upper plate of the case 321 and between the second plate 323b and a lower plate of the case 321. Accordingly, an electric field may be generated between the plurality of plates 323a and 323b and the connector 322, between the first plate 323a and the upper plate of the case 321, and between the second plate 323b and the lower plate of the case 321.

The coupler 311 may not be in contact with the case 321 but may penetrate through the case 321 so that one end of the coupler 311 is in contact with the oscillator (not shown) and another end of the coupler 311 is in contact with one area of the first plate 323a.

When microwaves generated in the oscillator (not shown) is transmitted to the plurality of plates 323a and 323b and the connector 322 through the coupler 311, an electric field may be generated inside an assembly of the plurality of plates 323a and 323b and the connector 322.

Also, according to a structure of the resonator 320 of the heater assembly 300, a triple resonance mode may be formed in the resonator 320. Resonance of a transverse electric and magnetic (TEM) mode of microwaves may be formed between the plurality of plates 323a and 323b. Also, resonance of a TEM mode, which is different from the resonance formed between the plurality of plates 323a and 323b, may be formed between the first plate 323a and the upper plate of the case 321 and between the second plate 323b and the lower plate of the case 321.

When triple resonance is generated in the resonator 320 of the heater assembly 300, the aerosol generating article 10 may be further effectively and uniformly heated.

The aerosol generating article 10 inserted into the accommodating space 320h of the case 321 may be heated by using a dielectric heating method by being surrounded by the first plate 323a and the second plate 323b. For example, a portion of the aerosol generating article 10 inserted into the accommodating space 320h of the case 321, the portion including a medium of the aerosol generating article 10, may be arranged in a space between the first plate 323a and the second plate 323b. The dielectric included in the aerosol generating article 10 may generate heat by the electric field generated in the space between the first plate 323a and the second plate 323b, and thus, the aerosol generating article 10 may be heated.

Also, the aerosol generating article 10 may be secondarily heated by an effect of the electric field generated by a resonance mode formed between the first plate 323a and the upper plate of the case 321 and between the second plate 323b and the lower plate of the case 321.

When the aerosol generating article 10 is inserted into the resonator 320 through the accommodating space 320h, the tobacco rod 11 of the aerosol generating article 10 may be located between the plurality of plates 323a and 323b.

A length L4 of the tobacco rod 11 may be greater than a length L1 of the plurality of plates 323a and 323b. Accordingly, a front end portion 11f of the tobacco rod 11 in contact with the filter rod 12 protrudes farther than the other end 323af of the first plate 323a and the other end 323bf of the second plate 323b in a direction facing the first opening 321a of the case 321.

A resonance peak may be formed at other end of the plurality of plates 323a and 323b operating as a resonator, and thus, an electric field stronger than other areas may be generated. When the aerosol generating article 10 is inserted into the heater assembly 300, the tobacco rod 11 including a dielectric capable of generating heat by an electric field may be arranged to correspond to an area with the strongest electric field, and thus, heating efficiency (or dielectric heating efficiency) of the heater assembly 300 may be improved.

Referring to FIG. 6, the length L1 of the plurality of plates 323a and 323b may be smaller than a length (L1+L2) of the internal space of the case 321. Accordingly, the other end of the plurality of plates 323a and 323b may be located at a more inner side of the case 321 than the first opening 321a. In other words, the other end of the plurality of plates 323a and 323b may be spaced apart from a rear end portion of the first opening 321a by a distance of a length L2.

A length from the rear end portion of the first opening 321a, where the first opening 321a is connected to the case 321, to the front end portion of the first opening 321a, where the first opening 321a is open, may be L3. An entire length of the case 321 in a length direction of the case 321 may be L. The entire length L of the case 321 may be determined by a total sum of the length L1 of the plurality of plates 323a and 323b, the length L2 in which the plurality of plates 323a and 323b and the rear end portion of the first opening 321a are separated from each other, and the length L3 of the first opening 321a protruding from the case 321.

To prevent leakage of microwaves, the front end portion of the first opening 321a, where the first opening 321a is open, may protrude by the length L3 from the case 321. When the first opening 321a of the case 321 protrudes from the case 321, the first opening 321a may prevent microwaves inside the case 321 of the resonator 320 from leaking to the outside of the case 321.

The resonator 320 may further include a dielectric accommodating space 327 for accommodating the dielectric. The dielectric accommodating space 327 may be formed in an empty space between the case 321 and the plurality of plates 323a and 323b. The dielectric accommodating space 327 may accommodate a dielectric having a low degree of microwave absorption.

By arranging the dielectric inside the dielectric accommodating space 327, an overall size of the resonator 320 of the heater assembly 300 may be reduced while generating an electric field of a same level as an electric field generated in a resonator that does not include a dielectric. In other words, the size of the resonator 320 may be reduced through the dielectric arranged inside the dielectric accommodating space 327, thereby reducing a mounting space of the resonator 320 in the aerosol generating device, and thus, the aerosol generating device may be miniaturized.

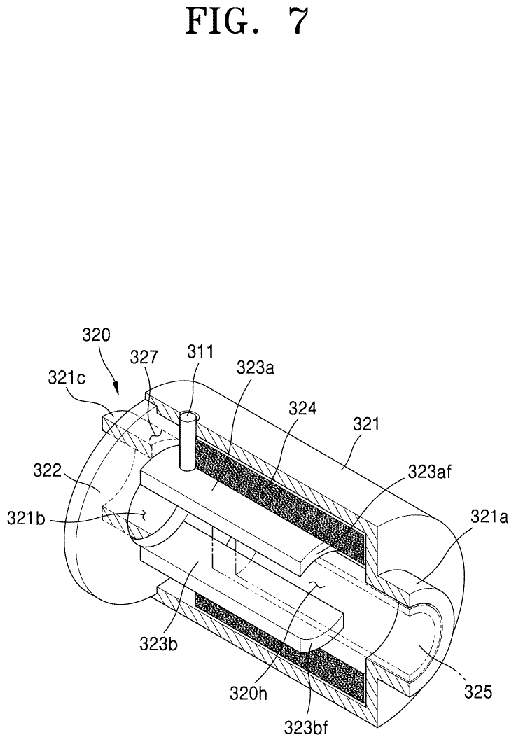

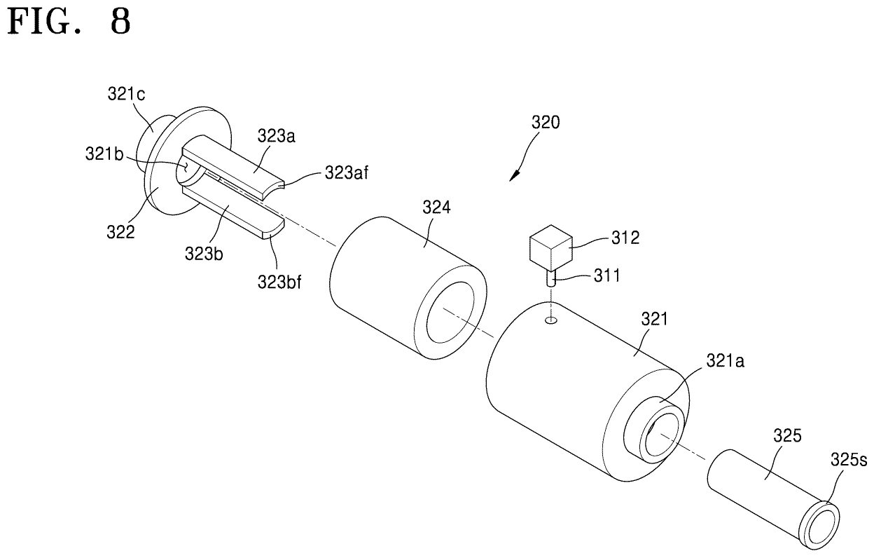

FIG. 7 is a perspective view schematically illustrating a heater assembly by cutting a portion thereof, according to another embodiment, and FIG. 8 is an exploded perspective view schematically illustrating components of the heater assembly of FIG. 7, according to an embodiment.

The heater assembly of FIGS. 7 and 8 according to an embodiment may include the resonator 320 configured to generate microwave resonance and the coupler 311 configured to supply microwaves to the resonator 320.

The case 321 of the resonator 320 may include the accommodating space 320h in which an aerosol generating article may be accommodated, and the first opening 321a into which the aerosol generating article may be inserted. The case 321 may include a hollow cylindrical shape extending along a length direction in which the aerosol generating article is inserted.

The one end of the plurality of plates 323a and 323b of the resonator 320 may be connected to the case 321 via the connector 322. The other end of the plurality of plates 323a and 323b may be open towards the first opening 321a of the case 321.

The plurality of plates 323a and 323b may include the first plate 323a and the second plate 323b spaced apart from each other along a circumferential direction of the aerosol generating article accommodated in the accommodating space 320h.

The plurality of plates 323a and 323b extend in a length direction of the case 321. At least a portion of the plurality of plates 323a and 323b may be curved to protrude outward from a center of the length direction of the accommodating space 320h in which the aerosol generating article is accommodated. The first plate 323a may extend while being curved in the circumferential direction of the aerosol generating article to surround one area of the aerosol generating article. The second plate 323b may extend while being curved in the circumferential direction of the aerosol generating article to surround another area of the aerosol generating article.

The other end 323af of the first plate 323a and the other end 323bf of the second plate 323b may be spaced apart from each other and open. Because the other end of the plurality of plates 323a and 323b are spaced apart from each other, the open end portion may be formed at the other end of the plurality of plates 323a and 323b.

The open end portion at the other end of the plurality of plates 323a and 323b may be located to face the first opening 321a of the case 321. The first opening 321a of the case 321 may be separated in a direction away from an end portion of the other end of the plurality of plates 323a and 323b.

The connector 322 may include the second opening 321b corresponding to the first opening 321a, at a location facing the first opening 321a. The second opening 321b may be formed in the connector 322 for fluid communication with the first opening 321a. For example, the second opening 321b may be aligned in the length direction of the aerosol generating article 10 with respect to the first opening 321a and the open end portion of the other end 323af of the plurality of plates 323a and 323b. Thus, one end of the aerosol generating article 10 according to an embodiment may be inserted through the first opening 321a of the case 321 and pass through the second opening 321b of the connector 322. Here, an outer circumferential surface of the aerosol generating article 10 may include the band (not shown) indicating the insertion location. When the band of the aerosol generating article 10 is located at the front end portion of the first opening 321a, the tobacco rod 11 may be arranged to correspond to an area where an electric field is strongest.

The shape and size of the second opening 321b according to an embodiment may correspond to the shape and size of the first opening 321a. For example, when the first opening 321a has a circular shape, the second opening 321b also has a circular shape, and the inner diameter of the first opening 321a and the inner diameter of the second opening 321b may be substantially the same.

The connector 322 may have one surface where the plurality of plates 323a and 323b are arranged, and another surface including the tubular protruding portion 321c extending from the second opening 321b. The tubular protruding portion 321c may be aligned in the length direction of the aerosol generating article 10 with respect to the second opening 321b, the open end portion of the other end 323af of the plurality of plates 323a and 323b, and the first opening 321a.

The one end of the first plate 323a and the one end of the second plate 323b may be arranged along the circumference of the second opening 321b of the connector 322. Also, the other end 323af of the first plate 323a and the other end 323bf of the second plate 323b may be spaced apart from each other and open. A resonator assembly may be completed as the plurality of plates 323a and 323b are connected to the connector 322.

The resonator 320 may further include the dielectric accommodating space 327 for accommodating the dielectric. The dielectric accommodating space 327 may be formed in an empty space between the case 321 and the plurality of plates 323a and 323b. The dielectric accommodating space 327 may accommodate a dielectric 324 having a low degree of microwave absorption.

The dielectric 324 may include a cylindrical shape with a hollow interior. The plurality of plates 323a and 323b may be inserted into an empty space inside the dielectric 324, and thus, the dielectric 324 may be mounted in the dielectric accommodating space 327. The dielectric 324 may protrude towards the first opening 321a farther than the other end of the plurality of plates 323a and 323b, in a length direction in which the case 321 extends.

By arranging the dielectric 324 inside the dielectric accommodating space 327 of the resonator 320, an overall size of the resonator 320 may be reduced while generating an electric field of a same level as an electric field generated in a resonator that does not include a dielectric. In other words, the size of the resonator 320 may be reduced through the dielectric 324 arranged inside the dielectric accommodating space 327, thereby reducing a mounting space of the resonator 320 in the aerosol generating device, and thus, the aerosol generating device may be miniaturized.

An extractor 325 may be arranged inside the plurality of plates 323a and 323b. The extractor 325 may include a hollow cylindrical shape having one end closed and another end open. The extractor 325 may be detachably arranged between the plurality of plates 323a and 323b and perform a function of extracting the aerosol generating article from the accommodating space 320h. For example, when the user has completed smoking, the user may extract the extractor 325 and the aerosol generating article simultaneously from the accommodating space 320h by moving the extractor 325 in a direction of the front end portion of the first opening 321a while holding a portion of the extractor 325.

The extractor 325 has the one end closed and the other end open, and the other end may include a stopper 325s protruding outward from an outer circumferential surface of the extractor 325. In other words, a diameter of the stopper 325s is greater than a diameter of the first opening 321a, and thus, when the extractor 325 is inserted into the accommodating space 320h, the extractor 325 may move until a rear end portion of the stopper 325s is in contact with the front end portion of the first opening 321a.

A length from the one end to the other end of the extractor 325 may correspond to a length of the aerosol generating article. Referring to FIGS. 4 and 5, the lengths of the aerosol generating articles 10 and 20 may be vary depending on design necessity. According to an embodiment, lengths of the filter rods 12 and 22 of the aerosol generating articles 10 and 20 may be fixed and lengths of the tobacco rods 11 and 21 of the aerosol generating articles 10 and 20 may be changed to vary the entire lengths of the aerosol generating articles 10 and 20. For example, the lengths of the tobacco rods 11 and 21 of the aerosol generating articles 10 and 20 may be about 15 mm and about 25 mm, respectively. Also, the entire length of the aerosol generating article 20 may be greater than the entire length of the aerosol generating article 10 by a length of the front end plug 23. For example, the length of the front end plug 23 may be about 7 mm.

For optimal heating of the aerosol generating articles 10 and 20, the tobacco rods 11 and 21 may be arranged near the other end of the plurality of plates 323a and 323b, where a resonance peak is formed. In detail, front end portions of the tobacco rods 11 and 21, which are in contact with the filter rods 12 and 22, may be arranged between the other end of the plurality of plates 323a and 323b and one end of the dielectric 324.

When the user selects the extractor 325 corresponding to the length of the aerosol generating article, inserts the aerosol generating article into the selected extractor 325, and inserts the extractor 325 into the accommodating space 320h, the front end portions of the tobacco rods 11 and 21, which are in contact with the filter rods 12 and 22, may be arranged between the other end of the plurality of plates 323a and 323b and the one end of the dielectric 324.

The heater assembly 300 according to an embodiment may include the first opening 321a in the case 321 and the second opening 321b in the connector 322, the second opening 321b in fluid communication with the first opening 321a, and thus may include the resonator 320 having both end portions open. Accordingly, even when the lengths of the tobacco rods 11 and 21 and/or the length of the front end plug 23 are changed based on the front end portions of the tobacco rods 11 and 21, which are in contact with the filter rods 12 and 22, an optimal heating location may be identically maintained. In other words, rear end portions (or the front end plug 23) of the tobacco rods 11 and 21 may be arranged close to the second opening 321b so that the lengths of the tobacco rods 11 and 21 are increased based on the front end portions of the tobacco rods 11 and 21, which are in contact with the filter rods 12 and 22, and in some cases, the rear end portions (or the front end plug 23) of the tobacco rods 11 and 21 may pass through the second opening 321b and be arranged outside.

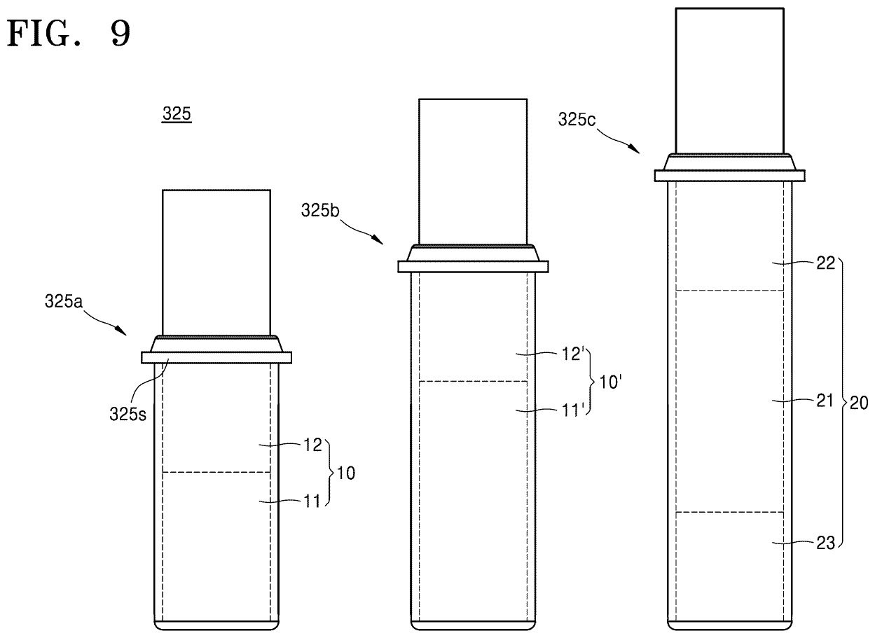

FIG. 7 is a perspective view schematically illustrating a heater assembly by cutting a portion thereof, according to another embodiment, and FIG. 8 is an exploded perspective view schematically illustrating components of the heater assembly of FIG. 7, according to an embodiment. FIG. 9 is a diagram for describing extractors 325a, 325b, and 325c with various lengths, into which aerosol generating articles 10, 10′, and 20 with various lengths are inserted.

The heater assembly of FIGS. 7 and 8 according to an embodiment may include the resonator 320 configured to generate microwave resonance and the coupler 311 configured to supply microwaves to the resonator 320.

The case 321 of the resonator 320 may include the accommodating space 320h in which an aerosol generating article may be accommodated, and the first opening 321a into which the aerosol generating article may be inserted. The case 321 may include a hollow cylindrical shape extending along a length direction in which the aerosol generating article is inserted.

The one end of the plurality of plates 323a and 323b of the resonator 320 may be connected to the case 321 via the connector 322. The other end of the plurality of plates 323a and 323b may be open towards the first opening 321a of the case 321.

The plurality of plates 323a and 323b may include the first plate 323a and the second plate 323b spaced apart from each other along a circumferential direction of the aerosol generating article accommodated in the accommodating space 320h.

The plurality of plates 323a and 323b extend in a length direction of the case 321. At least a portion of the plurality of plates 323a and 323b may be curved to protrude outward from a center of the length direction of the accommodating space 320h in which the aerosol generating article is accommodated. The first plate 323a may extend while being curved in the circumferential direction of the aerosol generating article to surround one area of the aerosol generating article. The second plate 323b may extend while being curved in the circumferential direction of the aerosol generating article to surround another area of the aerosol generating article.

The other end 323af of the first plate 323a and the other end 323bf of the second plate 323b may be spaced apart from each other and open. Because the other end of the plurality of plates 323a and 323b are spaced apart from each other, the open end portion may be formed at the other end of the plurality of plates 323a and 323b.

The open end portion at the other end of the plurality of plates 323a and 323b may be located to face the first opening 321a of the case 321. The first opening 321a of the case 321 may be separated in a direction away from an end portion of the other end of the plurality of plates 323a and 323b.

The connector 322 may include the second opening 321b corresponding to the first opening 321a, at a location facing the first opening 321a. The second opening 321b may be formed in the connector 322 for fluid communication with the first opening 321a. For example, the second opening 321b may be aligned in a length direction of the aerosol generating article 10 with respect to the first opening 321a and the open end portion of the other end 323af of the plurality of plates 323a and 323b. Thus, one end of the aerosol generating article 10 according to an embodiment may be inserted through the first opening 321a of the case 321 and pass through the second opening 321b of the connector 322. Here, the outer circumferential surface of the aerosol generating article 10 may include the band (not shown) indicating the insertion location. When the band of the aerosol generating article 10 is located at the front end portion of the first opening 321a, the tobacco rod 11 may be arranged to correspond to an area where an electric field is strongest.

The shape and size of the second opening 321b according to an embodiment may correspond to the shape and size of the first opening 321a. For example, when the first opening 321a has a circular shape, the second opening 321b also has a circular shape, and the inner diameter of the first opening 321a and the inner diameter of the second opening 321b may be substantially the same.

The one end of the first plate 323a and the one end of the second plate 323b may be arranged along the circumference of the second opening 321b of the connector 322. Also, the other end 323af of the first plate 323a and the other end 323bf of the second plate 323b may be spaced apart from each other and open. A resonator assembly may be completed as the plurality of plates 323a and 323b are connected to the connector 322.

The resonator 320 may further include the dielectric accommodating space 327 for accommodating the dielectric. The dielectric accommodating space 327 may be formed in the empty space between the case 321 and the plurality of plates 323a and 323b. The dielectric accommodating space 327 may accommodate the dielectric 324 having a low degree of microwave absorption.

The dielectric 324 may include a cylindrical shape with a hollow interior. The plurality of plates 323a and 323b may be inserted into an empty space inside the dielectric 324, and thus, the dielectric 324 may be mounted in the dielectric accommodating space 327. The dielectric 324 may protrude towards the first opening 321a farther than the other end of the plurality of plates 323a and 323b, in a length direction in which the case 321 extends.

By arranging the dielectric 324 inside the dielectric accommodating space 327 of the resonator 320, the overall size of the resonator 320 may be reduced while generating an electric field of a same level as an electric field generated in a resonator that does not include a dielectric. In other words, the size of the resonator 320 may be reduced through the dielectric 324 arranged inside the dielectric accommodating space 327, thereby reducing the mounting space of the resonator 320 in the aerosol generating device, and thus, the aerosol generating device may be miniaturized.

The extractor 325 may be arranged inside the plurality of plates 323a and 323b. The extractor 325 may include a hollow cylindrical shape having one end closed and another end open. The extractor 325 may be detachably arranged between the plurality of plates 323a and 323b and perform a function of extracting the aerosol generating article from the accommodating space 320h. For example, when the user has completed smoking, the user may extract the extractor 325 and the aerosol generating article simultaneously from the accommodating space 320h by moving the extractor 325 in a direction of the front end portion of the first opening 321a while holding a portion of the extractor 325.

The extractor 325 has the one end closed and the other end open, and the other end may include the stopper 325s protruding outward from the outer circumferential surface of the extractor 325. In other words, the diameter of the stopper 325s is greater than the diameter of the first opening 321a, and thus, when the extractor 325 is inserted into the accommodating space 320h, the extractor 325 may move until the rear end portion of the stopper 325s is in contact with the front end portion of the first opening 321a.

The resonator 320 may include an air introduction passage for introducing external air thereinto. The air introduction passage may be formed in the extractor 325 or between the extractor 325 and the case 321. When the user holds the aerosol generating article 10 in his/her mouth and performs an inhalation motion, the external air is introduced into the resonator 320 through the air introduction passage. The air is introduced into the aerosol generating article 10 through an end portion of the aerosol generating article 10. The air may be transferred to the user together with aerosols generated in the aerosol generating article 10, while passing through the aerosol generating article 10.

Further referring to FIG. 9, lengths of the extractors 325a, 325b, and 325c from one ends to other ends may correspond to lengths of the aerosol generating articles 10, 10′, and 20, respectively. The lengths of the aerosol generating articles 10, 10′, and 20 may vary depending on design necessity. According to an embodiment, lengths of filter rods 12, 12′, and 22 of the aerosol generating articles 10, 10′, and 20 may be fixed and lengths of tobacco rods 11, 11′, and 21 of the aerosol generating articles 10, 10′, and 20 may be changed so that entire lengths of the aerosol generating articles 10, 10′, and 20 may vary.

For example, the length of the tobacco rod 11 of the aerosol generating article 10 may be about 15 mm, and the lengths of the tobacco rods 11′ and 21 of the aerosol generating articles 10′ and 20 may be about 25 mm. Also, the entire length of the aerosol generating article 20 may be greater than the entire length of the aerosol generating article 10′ by a length of the front end plug 23. For example, the length of the front end plug 23 may be about 7 mm. Here, the lengths of the filter rods 12, 12′, and 22 of the aerosol generating articles 10, 10′, and 20 may be the same.

For optimal heating of the aerosol generating articles 10, 10′, and 20, the tobacco rods 11, 11′, and 21 may be arranged near the other end of the plurality of plates 323a and 323b, where a resonance peak is formed. In detail, front end portions of the tobacco rods 11, 11′, and 21, which are in contact with the filter rods 12, 12′, and 22, may be arranged between the other end of the plurality of plates 323a and 323b and one end of the dielectric 324.

When the user selects the extractors 325a, 325b, and 325c respectively corresponding to the lengths of the aerosol generating articles 10, 10′, and 20, inserts the aerosol generating articles 10, 10′, and 20 into the selected extractors 325a, 325b, and 325c, and inserts the extractors 325a, 325b, and 325c into the accommodating space 320h, the front end portions of the tobacco rods 11, 11′, and 21, which are in contact with the filter rods 12, 12′, and 22, may be arranged between the other end of the plurality of plates 323a and 323b and the one end of the dielectric 324.

The heater assembly 300 according to an embodiment may include the first opening 321a in the case 321 and the second opening 321b in the connector 322, the second opening 321b in fluid communication with the first opening 321a, and thus may include the resonator 320 having both end portions open. Accordingly, even when the lengths of the tobacco rods 11, 11′, and 21 and/or the length of the front end plug 23 are changed based on the front end portions of the tobacco rods 11, 11′, and 21, which are in contact with the filter rods 12, 12′, and 22, an optimal heating location may be identically maintained. In other words, when the lengths of the tobacco rods 11, 11′, and 21 are increased based on the front end portions of the tobacco rods 11, 11′, and 21, which are in contact with the filter rods 12, 12′, and 22, rear end portions (or the front end plug 23) of the tobacco rods 11, 11′, and 21 may be arranged close to the second opening 321b, and in some cases, the rear end portions (or the front end plug 23) of the tobacco rods 11, 11′, and 21 may pass through the second opening 321b and be arranged outside.

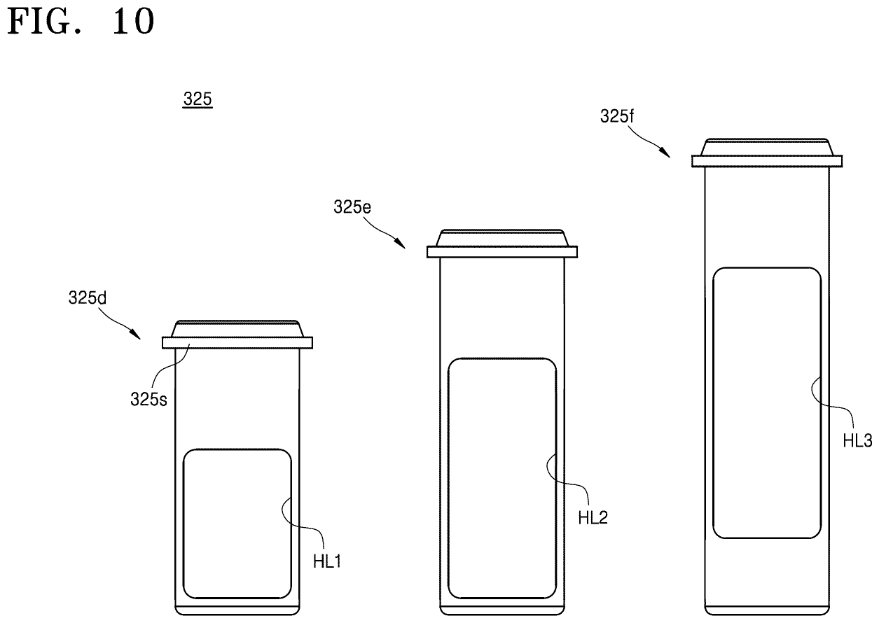

FIG. 10 is a diagram for describing extractors 325d, 325e, and 325f, including hole portions HL1, HL2, and HL3.

Referring to FIGS. 7 to 10, the extractors 325d, 325e, and 325f of FIG. 10 are substantially the same as the extractors 325a, 325b, and 325c of FIG. 9, except that the extractors 325d, 325e, and 325f further include the hole portions HL1, HL2, and HL3, respectively. Thus, redundant descriptions about same components will be omitted and differences will be mainly described.

The extractors 325d, 325e, and 325f include cavities into which the aerosol generating articles 10, 10′, and 20 are inserted, and at least one of the hole portions HL1, HL2, and HL3 enabling the cavities and the accommodating space 320h to communicate with each other may be formed on outer circumferential surfaces of the extractors 325d, 325e, and 325f.

Pluralities of the hole portions HL1, HL2, and HL3 of the extractors 325d, 325e, and 325f may be formed on outer circumferences of the extractors 325d, 325e, and 325f. Here, the pluralities of hole portions HL1, HL2, and HL3 may be spaced apart from each other at regular intervals. For example, two hole portions HL1, HL2, or HL3 may be formed in parallel, wherein the two hole portions HL1, HL2, or HL3 may be spaced part from each other at regular intervals. Here, the two hole portions HL1, HL2, or HL3 may face the outer circumferential surface of the extractor 325d, 325e, or 325f and have a same shape.

The hole portions HL1, HL2, and HL3 may be formed at locations corresponding to the tobacco rods 11, 11′, and 21, respectively. When the aerosol generating articles 10, 10′, and 20 are inserted into the cavities, portions of the aerosol generating articles 10, 10′, and 20 exposed through the hole portions HL1, HL2, and HL3 may be limited to the tobacco rods 11, 11′, and 21. Accordingly, heating efficiency of the tobacco rods 11, 11′, and 21 may be increased and airflow introduction into the extractors 325d, 325e, and 325f may be increased.

The extractor 325 may include a resin material having waterproof performance and/or thermal insulation performance, and for example, may include polytetrafluoroethylene (PTFE).

The extractor 325 may prevent droplets generated when aerosols are liquefied again or moisture generated in an aerosol generating article from being leaked to the outside of the extractor 325. Also, the extractor 325 may prevent heat generated at a location of the aerosol generating article from being leaked to the outside of the extractor 325. The extractor 325 may perform a leakage function of preventing liquid from leaking to other structures of the resonator 320 and a thermal insulation function of preventing heat from leaking.

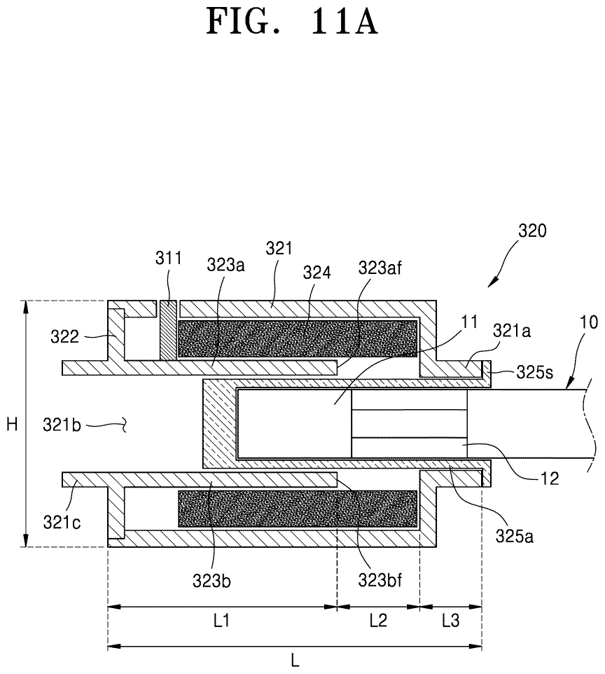

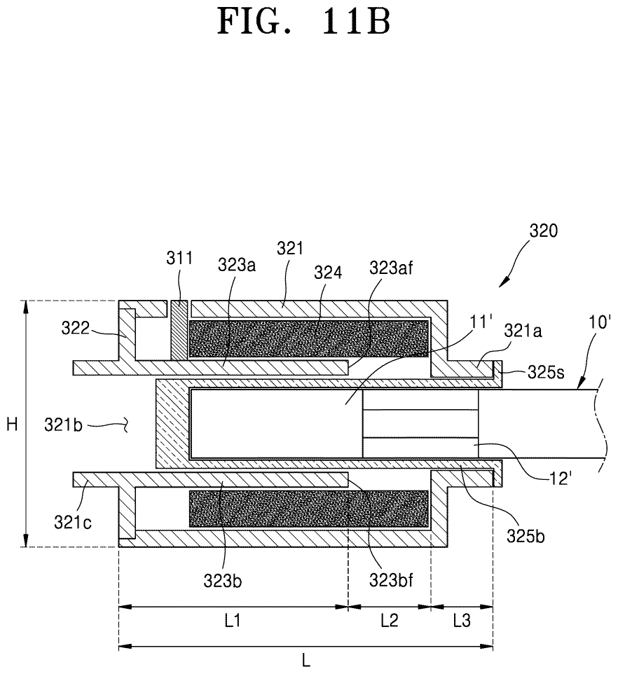

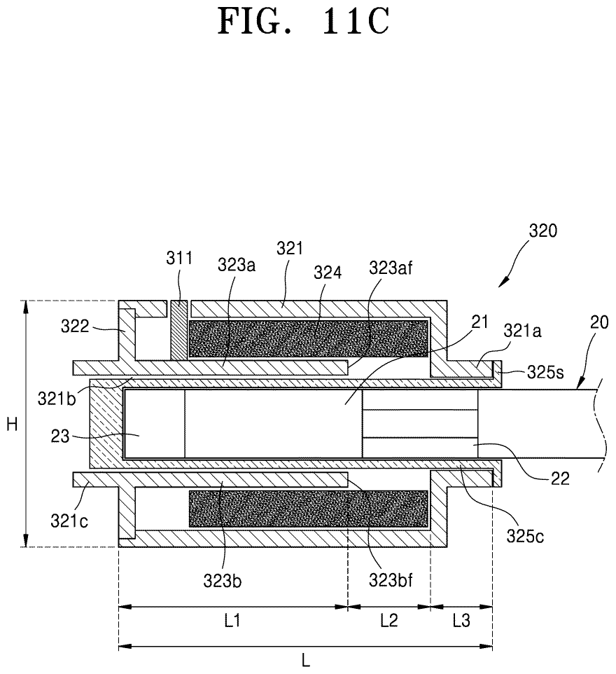

FIGS. 11A, 11B, and 11C are cross-sectional views showing states in which the extractors 325a, 325b, and 325c of FIG. 9 are inserted into the heater assembly of FIG. 7, respectively.

When the aerosol generating articles 10, 10′, and 20 are inserted into the extractors 325a, 325b, and 325c of the resonator 320, the tobacco rods 11, 11′, and 21 of the aerosol generating articles 10, 10′, and 20 may be located between the plurality of plates 323a and 323b. The diameter of the stopper 325s of the extractors 325a, 325b, and 325c is greater than the diameter of the first opening 321a, and thus, movement of the aerosol generating articles 10, 10′, and 20 in a left direction is restricted.

Front end portions of the tobacco rods 11, 11′, and 21 in contact with the filter rods 12, 12′, and 22 protrude farther than the other end 323af of the first plate 323a and the other end 323bf of the second plate 323b in a direction facing the first opening 321a of the case 321.

The length L1 of the plurality of plates 323a and 323b may be smaller than the length (L1+L2) of the internal space of the case 321. Accordingly, the other end of the plurality of plates 323a and 323b may be located at a more inner side of the case 321 than the first opening 321a. In other words, the other end of the plurality of plates 323a and 323b may be spaced apart from the rear end portion of the first opening 321a by the distance of the length L2.

The length L3 of the first opening 321a protruding from the case 321 may be L3. The entire length of the case 321 in the length direction of the case 321 may be L. The entire length L of the case 321 may be determined within a range of 25 mm to 35 mm, and the entire length L of the case 321 of FIGS. 11A, 11B, and 11C is about 29 mm. To prevent leakage of microwaves, the length L3 of the first opening 321a may be 5 mm or more.

A height H of the case 321 in a direction traversing the length direction of the case 321 may be determined within a range of 13 mm to 25 mm, and the height H of the case 321 of FIGS. 11A, 11B, and 11C is about 16 mm.

The front end portion of the dielectric 324 arranged in the resonator 320 may protrude farther than the other end of the plurality of plates 323a and 323b, towards the length direction of the case 321. In FIGS. 11A, 11B, and 11C, the front end portion of the dielectric 324 may be in contact with a right inner surface of the case 321. The length L2 in which the front end portion of the dielectric 324 protrudes farther than the other end of the plurality of plates 323a and 323b may be variously modified. Accordingly, the front end portion of the dielectric 324 may protrude farther than the other end of the plurality of plates 323a and 323b but may be spaced apart from the right inner surface of the case 321.

At least a portion of the first plate 323a from among the plurality of plates 323a and 323b may be in contact with the coupler 311. The coupler 311 and the first plate 323a may be in contact with each other at a location closer to the connector 322 than to the first opening 321a.

When microwaves are transmitted to the first plate 323a through the coupler 311, microwave resonance is generated between the plurality of plates 323a and 323b. Also, microwave resonance is generated between the first plate 323a and the upper plate of the case 321 and between the second plate 323b and the lower plate of the case 321. Accordingly, an electric field may be generated between the plurality of plates 323a and 323b and the connector 322, between the first plate 323a and the upper plate of the case 321, and between the second plate 323b and the lower plate of the case 321.

The connector 322 may include the second opening 321b corresponding to the first opening 321a, at a location facing the first opening 321a. The second opening 321b may be formed in the connector 322 for fluid communication with the first opening 321a.

Even when the lengths of the tobacco rods 11, 11′, and 21 and/or the length of the front end plug 23 are changed based on the front end portions of the tobacco rods 11, 11′, and 21, which are in contact with the filter rods 12, 12′, and 22, the optimal heating location may be identically maintained. In other words, when the lengths of the tobacco rods 11, 11′, and 21 are increased based on the front end portions of the tobacco rods 11, 11′, and 21, which are in contact with the filter rods 12, 12′, and 22, the rear end portions (or the front end plug 23) of the tobacco rods 11, 11′, and 21 may be arranged close to the second opening 321b, and in some cases, the front end plug 23 (or the extractor 325c) of the aerosol generating article 20 may be located inside the tubular protruding portion 321c by passing through the second opening 321b.

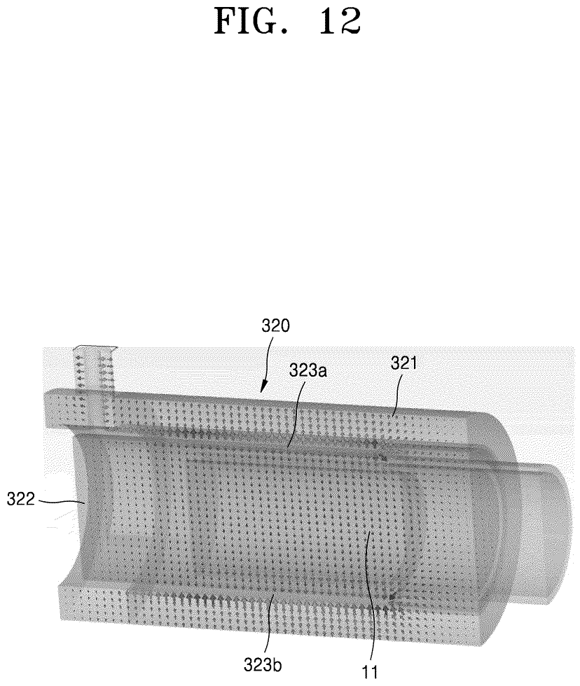

FIG. 12 is a perspective view schematically illustrating an electric field distribution of the heater assembly of FIG. 11A, according to an embodiment. The electric field distribution of FIG. 12 illustrates intensity of a voltage per unit length (V/m) of the resonator 320.

According to a structure of the resonator 320 of the heater assembly, a triple resonance mode may be formed in the resonator 320. Resonance of a transverse electric and magnetic (TEM) mode of microwaves may be formed between the plurality of plates 323a and 323b. Also, resonance of a TEM mode, which is different from the resonance formed between the plurality of plates 323a and 323b, may be formed between the first plate 323a and the upper plate of the case 321 and between the second plate 323b and the lower plate of the case 321.

When triple resonance is generated in the resonator 320 of the heater assembly, the aerosol generating article 10 may be further effectively and uniformly heated.

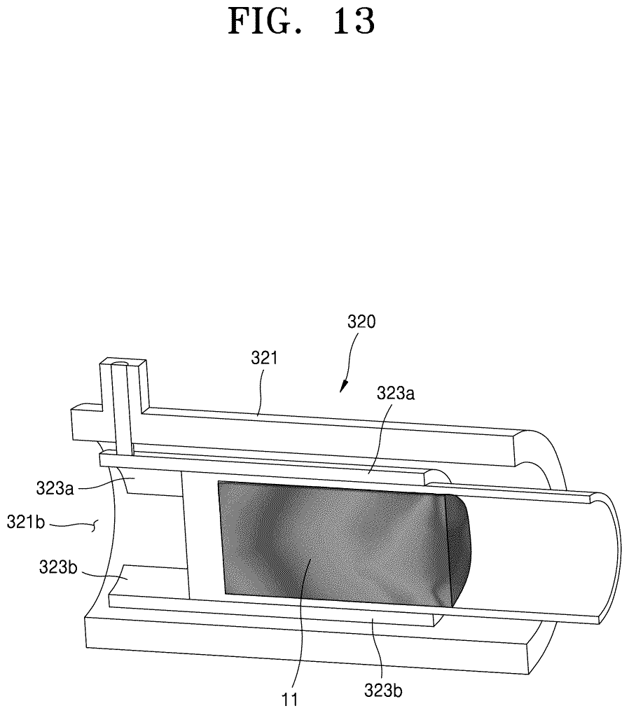

FIG. 13 is a perspective view schematically illustrating a heating density distribution of an aerosol generating article heated by the heater assembly of FIG. 11A, according to an embodiment. The heating density distribution of FIG. 13 indicates temperature energy per unit volume (W/m³) in each area of the aerosol generating article when the aerosol generating article is heated.

A resonance peak may be formed at other end of the plurality of plates 323a and 323b, and thus, an electric field stronger than other areas may be generated. Because the tobacco rod 11 including a dielectric that generates heat by an electric field of the aerosol generating article is arranged to correspond to an area of the resonator 320 where the electric field is strongest, a portion of the tobacco rod 11 may be heated at a highest temperature.

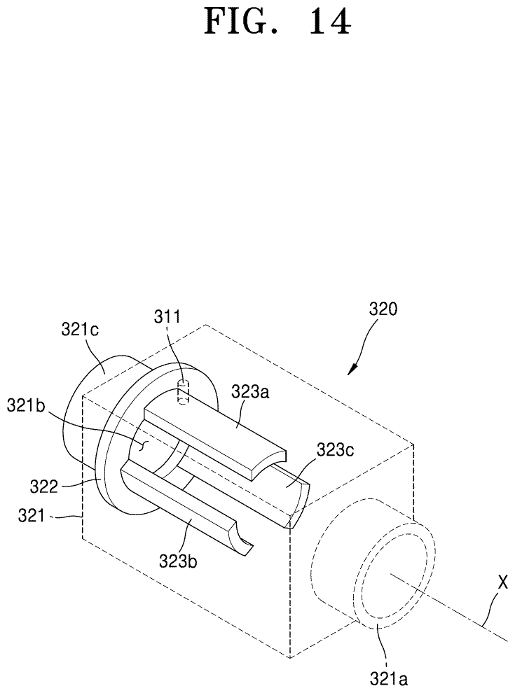

FIG. 14 is a perspective view schematically illustrating a heater assembly according to another embodiment.

The resonator 320 of FIG. 14 is substantially the same as the embodiment of FIG. 6, except that the resonator 320 of FIG. 14 includes three plates whereas the embodiment of FIG. 6 includes two plates. Thus, redundant descriptions about same components will be omitted and differences will be mainly described.

A plurality of plates of the resonator 320 may include the first plate 323a, the second plate 323b, and a third plate 323c, which are spaced apart from each other along a circumferential direction of an aerosol generating article accommodated in the accommodating space 320h.

Three plates are spaced apart from each other in a circumferential direction based on a central axis X of a length direction of the aerosol generating article accommodated in the case 321. Embodiments are not limited by the number of plurality of plates, and the number of plurality of plates may be, for example, 4 or more.

A resonator assembly may be completed when the first plate 323a, the second plate 323b, and the third plate 323c are connected to the connector 322.

Other ends of the first plate 323a, the second plate 323b, and the third plate 323c are spaced apart from each other and open towards the first opening 321a of the case 321, and thus, open end portions may be formed at the other ends of the first plate 323a, the second plate 323b, and the third plate 323c.

The first plate 323a, the second plate 323b, and the third plate 323c extend in the length direction of the case 321. At least a portion of the plurality of plates may be curved to protrude outward from a center of the length direction of the accommodating space 320h in which the aerosol generating article is accommodated. Each of the first plate 323a, the second plate 323b, and the third plate 323c may extend while being curved in a circumferential direction of the aerosol generating article so as to surround other areas of the aerosol generating article.

According to a structure in which the first plate 323a, the second plate 323b, and the third plate 323c are curved in the circumferential direction and spaced apart from each other along the outer circumferential surface of the aerosol generating article, a further uniform electric field is formed in the resonator 320, and thus, the heater assembly may uniformly heat the aerosol generating article 10.

Any embodiments of the present disclosure or other embodiments described above are not mutually exclusive or distinct from each other. Any embodiment or other embodiments described in this disclosure may be combined with one another, both in terms of configurations and functions.

For example, configuration A from a specific embodiment and/or drawing can be combined with configuration B from another embodiment and/or drawing. This means that even if a combination of components is not explicitly described, such combinations are still possible unless specifically stated otherwise.

The detailed description above should not be interpreted as limiting in any respect, but rather as illustrative. The scope of the present invention should be defined by a reasonable interpretation of the appended claims, and all modifications that fall within the equivalent scope of the present invention are included in its scope.

A heater assembly and an aerosol generating device, according to an embodiment, include a resonator having both end portions open, and thus may adaptively respond to a shape and size of an aerosol generating article.

Effects of embodiments are not limited to the above-described effects, and effects that are not mentioned will be clearly understood by one of ordinary skill in the art from the present specification and the accompanying drawings.

What is claimed is:

1. A heater assembly comprising:
an oscillator configured to generate microwaves in a specific frequency band;
a resonator configured to generate an electric field by resonating the microwaves; and
a coupler configured to transmit the generated microwaves to the resonator,
wherein the resonator comprises:
a case including an accommodating space accommodating an aerosol generating article and a first opening into which the aerosol generating article is insertable;
a plurality of plates spaced apart from each other along a circumferential direction of the aerosol generating article accommodated in the accommodating space; and
a connector connecting the plurality of plates and the case and including a second opening corresponding to the first opening, at a location facing the first opening.

2. The heater assembly of claim 1, wherein the first opening and the second opening are formed to be in fluid communication with each other, and a shape and size of the second opening correspond to a shape and size of the first opening.

3. The heater assembly of claim 1, further comprising an extractor detachably arranged between the plurality of plates and extracting the aerosol generating article from the accommodating space.

4. The heater assembly of claim 3, wherein the extractor has one end closed and another end open, and the another end includes a stopper protruding outward from an outer circumferential surface of the extractor.

5. The heater assembly of claim 4, wherein a length of the extractor from one end to the another end corresponds to a length of the aerosol generating article.

6. The heater assembly of claim 3, wherein the extractor comprises a cavity into which the aerosol generating article is inserted, and at least one hole portion enabling the cavity and the accommodating space to communicate with each other is formed on an outer circumferential surface of the extractor.

7. The heater assembly of claim 6, wherein the aerosol generating article comprises a tobacco rod and a filter rod, and the at least one hole portion is formed at a location corresponding to the tobacco rod.

8. The heater assembly of claim 1, wherein one ends of the plurality of plates are connected to the connector and other ends of the plurality of plates are spaced apart from each other and open.

9. The heater assembly of claim 8, wherein the one ends of the plurality of plates are arranged along a circumference of the second opening and the other ends of the plurality of plates are arranged to face the second opening of the case.

10. The heater assembly of claim 8, wherein the plurality of plates extend in a length direction of the aerosol generating article and at least some of the plurality of plates protrude outward from a center of the length direction of the aerosol generating article.

11. The heater assembly of claim 8, wherein the case and the plurality of plates are spaced apart from each other and the heater assembly further comprises a dielectric arranged between the case and the plurality of plates.

12. The heater assembly of claim 11, wherein one end of the dielectric protrudes towards the first opening from the other ends of the plurality of plates.

13. The heater assembly of claim 12, wherein the aerosol generating article comprises a tobacco rod and a filter rod, and a front end portion of the tobacco rod, which is in contact with the filter rod, is arranged between the other ends of the plurality of plates and the one end of the dielectric.

14. The heater assembly of claim 1, wherein the coupler is in contact with any one of the plurality of plates by penetrating through the case.

15. An aerosol generating device comprising:
a housing including an insertion hole into which an aerosol generating article is inserted; and
a heater assembly configured to heat the aerosol generating article inserted through the insertion hole,
wherein the heater assembly comprises:
an oscillator configured to generate microwaves in a specific frequency band;
a resonator configured to generate an electric field by resonating the microwaves; and
a coupler configured to transmit the generated microwaves to the resonator,
wherein the resonator comprises:
a case including an accommodating space accommodating the aerosol generating article and a first opening into which the aerosol generating article is insertable;
a plurality of plates spaced apart from each other along a circumferential direction of the aerosol generating article accommodated in the accommodating space; and
a connector connecting the plurality of plates and the case and including a second opening corresponding to the first opening, at a location facing the first opening.
